(19) United States
(12) Patent Application Publication
(10) Pub. No.: US 2009/0039301 A1
(43) Pub. Date: Feb. 12, 2009

(54) Controller for Oil Control Valve

(75) Inventor: Hiroyuki MIDORIKAWA, Takanezawa (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/188,101

(22) Filed: Aug. 7, 2008

(30) Foreign Application Priority Data
Aug. 8, 2007 (JP) 2007-206053

(51) Int. Cl. F16K 31/02; F16K 31/44

(52) U.S. Cl. 251/129.15; 251/251

(57) ABSTRACT

According to the invention, a malfunction due to catch of a foreign matter in a variable valve timing mechanism is prevented. In an internal combustion engine including a variable valve timing mechanism, when feedback control of an actuator is conducted so that an actual cam phase corresponds to a target cam phase calculated depending on an engine operation condition, if the target cam phase changes by a change in the engine operating condition, the actuator is controlled with a predetermined control value different from the feedback control only for a predetermined time thereafter.

### BACKGROUND OF THE INVENTION

1. Field of the Invention

The present invention relates to a controller which controls an oil control valve of an internal combustion engine.

2. Description of Related Art

As a mechanism for adjusting the timing of opening and closing intake and exhaust valves of an internal combustion engine (hereinafter, referred to as a variable valve timing mechanism), there is known the one using hydraulic pressure, in which mechanism an oil control valve is provided for controlling the hydraulic pressure. The oil control valve includes an input port to which the hydraulic pressure is supplied from an oil pump, an output port which outputs regulated hydraulic pressure, a drain port, and the like. When regulating the output hydraulic pressure, the input port or the drain port may be made in an extremely small state in which the opening width thereof is about several tens μm for example, and therefore, a foreign matter such as metal powder and sludge included in the oil is caught in a small opening portion to cause malfunction of hydraulic control.

If the malfunction occurs when feedback control of the oil control valve is performed so that the opening and closing timing of the intake and exhaust valves becomes a target value, the opening and closing timing of the intake and exhaust valves deviates from the target value, and even if attempting to move a spool in a direction for reducing the deviation by the feedback control, the actual spool position is fixed due to the caught foreign matter, and further, the foreign matter gets jammed due to the feedback control and cannot flow out.

Accordingly, while the feedback control is continued, the state in which the opening and closing timing of the intake and exhaust valves deviates from the target value continues, and there is the fear of degrading the output characteristics and exhaust of the internal combustion engine.

In order to prevent such malfunction, there is known the art in which when determining that the valve timing changing operation by a variable valve timing mechanism is abnormal, an opening portion is opened by significantly moving the spool of the oil control valve to discharge a foreign matter together with the oil (see JP-B2-3098676, for example). JP-B2-3098676 discloses a control technique of detecting abnormality of the oil control valve from the fact that the opening and closing timing of the intake and exhaust valves differs from the target value or the like, and repeatedly changing the position of the spool of the oil control valve with a predetermined variation width.

### BRIEF SUMMARY OF THE INVENTION

However, in the above described conventional control technique, it is carried out only after detecting the abnormality to control the spool of the oil control valve so as to widely move to open the opening portion so that a foreign matter is discharged together with oil (hereinafter, referred to as foreign matter discharge control). Thus, it does not have no effect of preventing the foreign matter from being caught, and therefore the opening and closing timing of the intake and exhaust valves becomes different from the target value during a period until the foreign matter is discharged after detecting occurrence of the catch of the foreign matter, during which period there is the possibility that the output characteristics and exhaust of the internal combustion engine deteriorate.

Further, since the above described conventional foreign matter discharge control per se creates the state in which the opening and closing timing of the intake and exhaust valves differs from the target value, there is the fear that the output characteristics and exhaust of the internal combustion engine deteriorate while the foreign matter discharge control is carried out.

Accordingly, the present invention makes it possible to prevent catch of a foreign matter and to discharge the foreign matter even after catch of the foreign matter occurs, by carrying out the foreign matter discharge control regardless of whether a changing operation of the valve timing is abnormal or not.

According to the present invention, even while the foreign matter discharge control is carried out, influence on output characteristics of an internal combustion engine and degradation of exhaust can be suppressed to be lower as compared with the conventional control.

Other objects, features and advantages of the invention will become apparent from the following description of an embodiment of the invention taken in conjunction with the accompanying drawings.

### BRIEF DESCRIPTION OF THE SEVERAL VIEWS OF THE DRAWINGS

FIG. 1 is a configuration diagram of an engine control system;

FIG. 2 is a configuration diagram of the engine control system;

FIG. 3 is a configuration diagram of an engine controller;

FIG. 4 is a structure diagram of a variable valve timing mechanism;

FIGS. 5A-5C are explanatory diagrams of an operation of an oil control valve;

FIG. 6 is an explanatory diagram of explaining a foreign matter catch state in the oil control valve;

FIG. 7 is an operation time chart of a target cam phase and a solenoid control parameter;

FIG. 8 is an operation characteristic diagram of the variable valve timing mechanism depending on the difference in temperature condition;

FIG. 9 is an operation time chart of the target cam phase and the solenoid control parameter; and

FIG. 10 is an operation time chart of the target cam phase and the solenoid control parameter with respect to the engine speed.

### DETAILED DESCRIPTION OF THE INVENTION

Hereinafter, the best modes for carrying out the present invention will be described.

As a first embodiment, a controller for an oil control valve is characterized in that when conducting feedback control of an actuator so that an actual cam phase corresponds to a target cam phase which is calculated in accordance with an engine operation condition, if the target cam phase changes due to a change in the engine operation condition, the controller for an oil control valve controls the actuator with a predetermined control value differing from the feedback control only for a predetermined time period thereafter.

By adopting such a configuration, a foreign matter can be removed at a stage before abnormality of a changing operation of valve timing obviously occurs due to the foreign matter by carrying out foreign matter discharge control regardless of whether the changing operation of the valve timing is abnormal or not, and degradation of the output characteristics and exhaust gas of the internal combustion engine can be prevented.

Further, even when the abnormality of the changing operation of the valve timing due to the foreign matter has already occurred, the feedback control is intermitted and the foreign matter discharge control is carried out regardless of whether the changing operation of the valve timing is abnormal or not. Therefore, the foreign matter can be removed, and the degradation of the output characteristic and exhaust gas of the internal combustion engine can be prevented.

As a second embodiment, in addition to the characteristic of the first embodiment, the controller for an oil control valve is characterized in that when a changing direction of the target cam phase is an advance direction, a control value with which a rotational phase of a cam shaft operates in an advance direction is set as the predetermined control value, and when the changing direction of the target cam phase is in a delay direction contrary, a control value with which the rotational phase of the cam shaft also operates in the delay direction is set as the predetermined control value.

As a third embodiment, in addition to the characteristics of the first embodiment and the second embodiment, the controller of an oil control valve is characterized in that when a changing amount per unit time of the target cam phase is large, control is conducted by setting a time period which is longer as compared when the changing amount is small as the predetermined time period.

When the foreign matter discharge control is carried out regardless of whether the changing operation of the valve timing is abnormal or not, deviation is caused between the target cam phase and the actual cam phase, but in the second embodiment, the actuator is controlled so that the rotational phase of the cam shaft changes in the same direction as the changing direction of the target cam phase, and further in the third embodiment, the foreign matter discharge control is carried out only for an optimal time period in accordance with the changing amount per unit time of the target cam phase. Therefore, the deviation between the target cam phase and the actual cam phase is suppressed to a minimum.

As a fourth embodiment, in addition to the characteristics of the first embodiment to the third embodiment, the controller for an oil control valve is characterized in that the control of the actuator with a predetermined control value differing from the feedback control is carried out with a frequency lower than a frequency of change of the target cam phase.

When a change in the operating state such that a change in the target cam phase occurs a plurality of times for a short time period occurs even though the countermeasures of the second embodiment and the third embodiment are carried out, the foreign matter discharge control is continuously carried out, and deviation between the target cam phase and the actual cam phase may become large. Therefore, by carrying out the countermeasure of the fourth embodiment, the frequency of the foreign matter discharge control is reduced and continuous implementation of the foreign matter discharge control can be avoided. Thus, the deviation between the target cam phase and the actual cam phase can be suppressed to a minimum.

As a fifth embodiment, in addition to the characteristics of the first embodiment to the fourth embodiment, the controller for an oil control valve is characterized in that until the internal combustion engine stops after it starts, the frequency with which the actuator is controlled with a predetermined control value differing from the feedback control is restricted to a predetermined frequency or less.

In an internal combustion engine used for a hybrid automobile including both internal combustion engine and generator as motive power, the target cam phase may also change with a preset pattern in accordance with a characteristic change in an operating state at the time of start and immediately after the start. Therefore, in the fifth embodiment, the foreign matter discharge control can be carried out only at the time of start of the internal combustion engine and immediately after the start, and the deviation between the target cam phase and the actual cam phase can be suppressed to a minimum.

Since the feedback control of the actual cam phase with respect to the target cam phase temporarily stops when the foreign matter discharge control is carried out, the foreign matter discharge control should be prohibited if the minimum required frequency can be secured since implementation of the foreign matter discharge control with a frequency higher than the minimum frequency causes degradation of the output characteristics and exhaust gas of the internal combustion engine. The fourth embodiment and the fifth embodiment provide the effect of restraining the foreign matter discharge control from being carried out more than required.

Configuration examples of the embodiments of the present invention will be described by using the drawings.

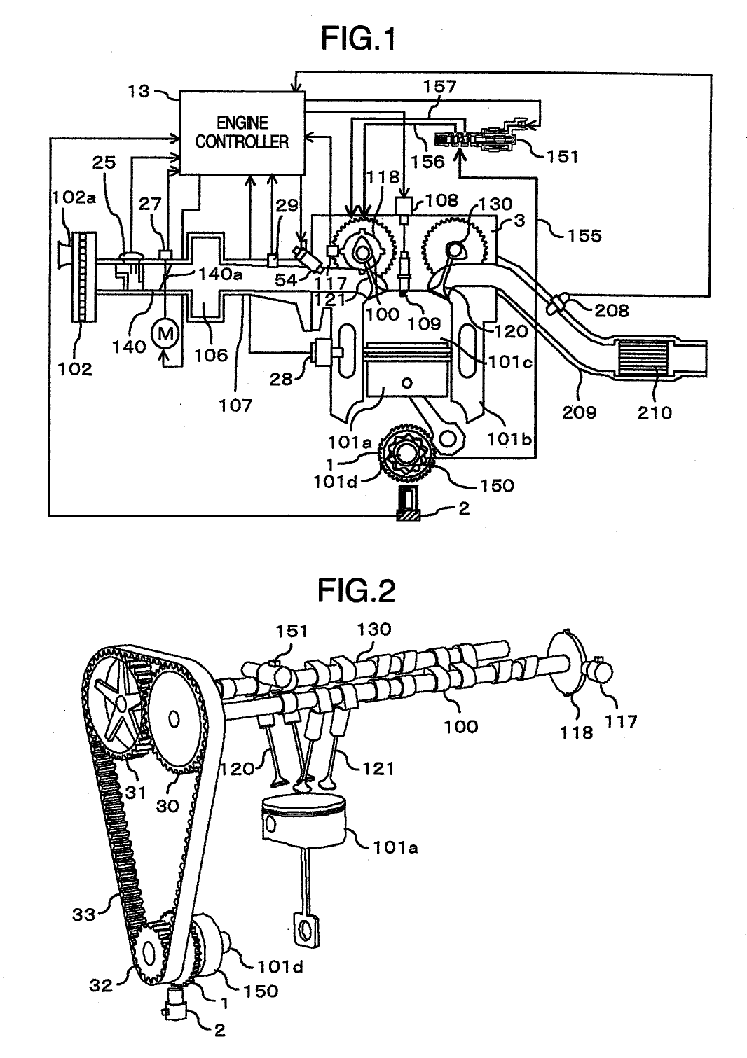

FIGS. 1 and 2 show a configuration example of an internal combustion engine described in the aforementioned first to fifth embodiments.

In the embodiments, a controller for an oil control valve is included in an engine controller 13.

An engine 3 includes a plurality of cylinders (not illustrated). The air introduced into a cylinder 101b is taken in from an inlet portion 102a of an air cleaner 102, passes through an intake air amount sensor (air flow sensor 25) and through a throttle body 140 housing an electrically controlled throttle valve 140a which controls the intake air amount, and enters a collector 106. The opening degree of the electrically controlled throttle valve 140a is controlled by the engine controller 13. The air sucked by the collector 106 is distributed to each intake pipe 107 connected to the cylinder 101b of the engine 3, and thereafter is introduced into a combustion chamber 101c formed by a piston 101a, the cylinder 101b and the like. Further, a signal indicating the intake air amount is output to the engine controller 13 from the air flow sensor 25. Further, a throttle sensor 27 which detects the opening degree of the electrically controlled throttle valve 140a is attached to the throttle body 140, and a signal thereof is also output to the engine controller 13.

Meanwhile, a fuel such as gasoline is fed from a fuel tank (not illustrated) and pressurized by a fuel pump (not illustrated), and thereafter, passes through a fuel pipe (not illustrated) and is injected to the combustion chamber 101c from an injector 54 provided in the cylinder 101b. The fuel injected into the combustion chamber 101c is ignited with an ignition plug 109 by an ignition signal raised to a high voltage with an ignition coil 108.

A rotator 1 and a rotational angle detecting sensor 2 attached to a crankshaft 101d of the engine 3 output a signal indicating a rotational position of the crankshaft 101d to the engine controller 13, and a rotator 118 and a cam angle sensor 117 attached to an intake cam shaft 100 of an intake valve 121 output an angle signal indicating a rotational position of the cam shaft to the engine controller 13. In the present embodiment, the crankshaft 101d is equipped with a mechanical type oil pump 150, but the oil pump is not limited to a mechanical type, and may be an electric oil pump.

An exhaust pipe 209 is provided with an air-fuel ratio sensor 208 which detects an oxygen concentration in exhaust gas and outputs a detection signal to the engine controller 13, an exhaust gas purifying catalyst 210 and the like.

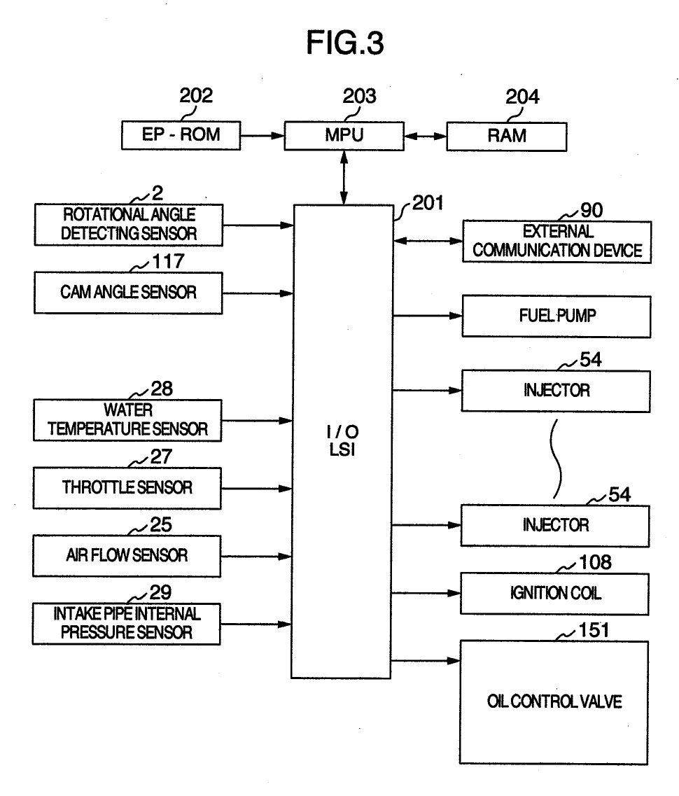

Next, a configuration of the engine controller 13 and an engine control method will be described by using FIG. 3. A main part of the engine controller 13 is configured by an MPU 203, an EP-ROM 202, a RAM 204, an I/O LSI (input and output circuit 201) including an A/D converter, and the like. The engine controller 13 takes in signals from various sensors and the like including the rotational angle detecting sensor 2 of the crank, the cam angle sensor 117, a water temperature sensor 28 which measures an engine cooling water temperature, an intake pipe internal pressure sensor 29 which measures the pressure in an intake pipe, executes predetermined calculation processing, outputs various control signals calculated as a result of the calculation, supplies predetermined control signals to a fuel pump (not illustrated) which is an actuator, each injector 54 and ignition coil 108, an oil control valve 151 and the like to carry out fuel injection amount control, ignition timing control, cam phase control and the like.

Next, the structure and an operation of a variable valve timing mechanism will be described by using FIGS. 2, 4 and 5.

A variable phase cam pulley 30 is provided at one end of the intake cam shaft 100. The variable phase cam pulley is of a continuously variable phase type.

A cam pulley 31 with an invariable phase is provided at one end of an exhaust cam shaft 130.

A crank pulley 32 is fixed to the crankshaft 101d.

The variable phase cam pulley 30 and the cam pulley 31 are driven by the crank pulley 32 via a timing belt 33.

The variable phase cam pulley 30 has a built-in actuator driven by hydraulic pressure. The structure of the actuator will be explained. A vane 40 fixed to the intake cam shaft 100 is contained inside the variable phase cam pulley 30, and a space in which the vane 40 is operable in a rotational direction is provided around the vane 40. The space is partitioned into an advance chamber 41 and a delay chamber 42 by the vane 40. The advance chamber 41 is connected to a phase advance hydraulic passage 156, and the delay chamber 42 is connected to a phase delay hydraulic passage 157.

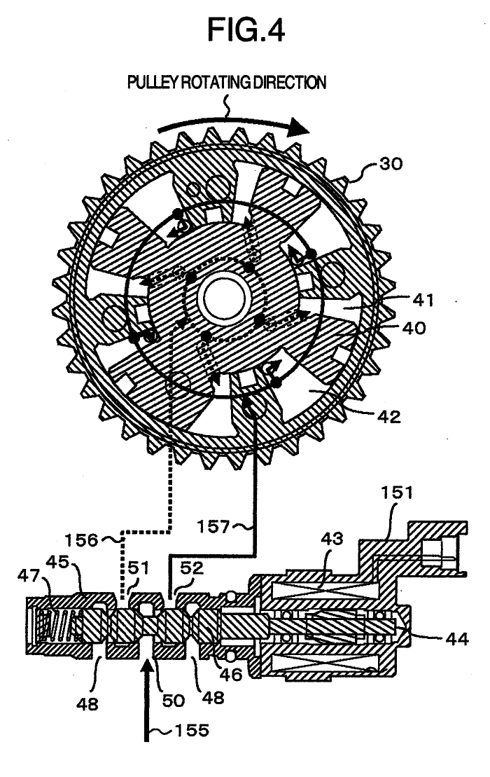

The oil control valve (OCV) 151 includes a solenoid 43, a plunger 44, a housing 45, a spool 46 and a spring 47, and in a state in which the current is not supplied to the solenoid 43, the spool 46 is pressed by the spring 47 to be located in a right direction in FIG. 4.

When the current is supplied to the solenoid 43, the plunger 44 presses the spool 46 in a left direction of FIG. 4, and therefore, the spool 46 overcomes the force of the spring 47 and moves in the left direction. The moving amount in the left direction of the spool 46 becomes large in proportion to the magnitude of the current supplied to the solenoid 43.

The housing 45 includes a hydraulic supply port 50, an advance port 51, a delay port 52, and a drain port 48. The hydraulic supply port 50 is connected to an oil passage 155, the advance port 51 is connected to the phase advance hydraulic passage 156, the delay port 52 is connected to the phase delay hydraulic passage 157, and the drain port 48 is connected to a drain passage not illustrated.

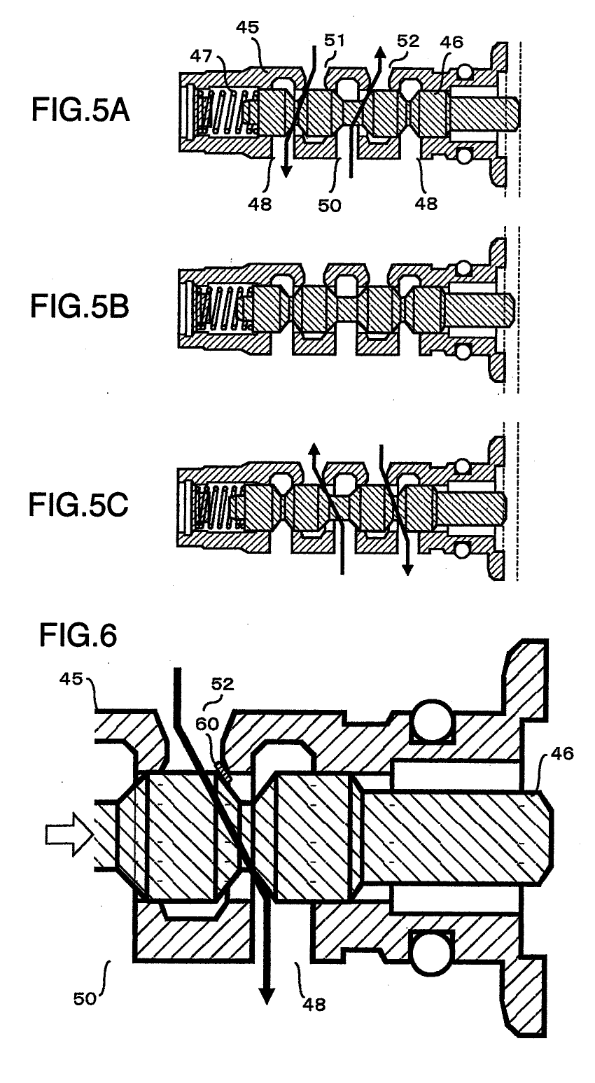

When the spool 46 is located in the right direction in the drawing as shown in FIG. 5A, the hydraulic supply port 50 and the delay port 52 communicate with each other, and at the same time, the drain port 48 and the advance port 51 communicate with each other. Therefore, the oil supplied from the oil pump 150 is guided to the delay chamber 42, and the oil in the advance chamber 41 is discharged to an oil pan through the drain passage. Therefore, the vane 40 changes its phase in the delay direction with respect to the variable phase cam pulley 30.

When the spool 46 is located at the center as in FIG. 5B, all of the hydraulic supply port 50, the advance port 51, the delay port 52 and the drain ports 48 are closed. Therefore, there is no flow of the oil, and the vane 40 does not change its phase with respect to the variable phase cam pulley 30.

When the spool 46 is located in the left direction in the drawing as shown in FIG. 5C, the hydraulic supply port 50 and the advance port 51 communicate with each other, and at the same time, the drain port 48 and the delay port 52 communicate with each other. Therefore, the oil supplied from the oil pump 150 is guided to the advance chamber 41, and the oil in the delay chamber 42 is discharged to the oil pan through the drain passage. Therefore, the vane 40 changes its phase in the advance direction with respect to the variable phase cam pulley 30.

Here, the vane 40 is fixed to the intake cam shaft 100, and the variable phase cam pulley 30 is connected to the crankshaft 101d via the timing belt 33. Therefore, the change in phase of the vane 40 and the variable phase cam pulley 30 is equivalent to the change in phase of the crankshaft 101d and the intake cam shaft 100.

The phase of the intake cam shaft 100 with respect to the crankshaft 101d (namely, the actual cam phase) is calculated by the engine controller 13 by using a signal indicating the rotational position of the crankshaft 101d that is output from the rotational angle detecting sensor 2 and a signal indicating the rotational position of the intake cam shaft 100 that is output from the cam angle sensor 117.

The engine controller 13 conducts feedback control of the current value of the solenoid 43 so that the target cam phase calculated based on the operating state detected from each sensor and the actual cam phase are equal to each other.

Here, as a method for controlling the current value of the solenoid 43, a method for changing the ratio (duty ratio) of the time in which a voltage is applied to the solenoid 43 and the time in which the voltage is not applied during a unit time is used.

When the duty ratio is made large, the current value of the solenoid 43 increases, the position of the spool 46 becomes as shown in FIG. 5C, and the actual cam phase moves in the advance direction. When the duty ratio is made small, the current value of the solenoid 43 decreases, and the position of the spool 46 becomes as shown in FIG. 5A, and the actual cam phase moves in the delay direction. When the duty ratio is made an intermediate value, the current of the solenoid 43 also becomes an intermediate value, the position of the spool 46 becomes as shown in FIG. 5B, and the actual cam phase does not change. The duty ratio and the position of the solenoid 43 in which the actual cam phase does not change will be called a neutral point hereinafter.

Next, an operation when a foreign matter is caught in the oil control valve 151 will be described by using FIG. 6.

When the spool 46 moves to a left side in the drawing and the actual cam phase moves in the advance direction, if a foreign matter 60 is caught between the housing 45 and the spool 46 in the delay port 52, the spool 46 cannot move in the right direction in the drawing. Therefore, the actual cam phase continues to move in the advance direction, so that the actual cam phase is advanced more than the target cam phase.

The engine controller 13 conducts the feedback control of the current value of the solenoid 43 so that the target cam phase and the actual cam phase are equal to each other. Therefore, in this state, the engine controller 13 controls the drive duty ratio of the solenoid 43 to be small so as to move the actual cam phase in the delay direction.

By this control, the spool 46 is pressed in the right direction in the drawing, and therefore, the foreign matter 60 is pinched between the housing 45 and the spool 46, and this state in which the foreign matter 60 is not allowed to flow continues.

That is, if the feedback control of the current value of the solenoid 43 is conducted so that the target cam phase and the actual cam phase become equal to each other when catch of a foreign matter occurs, the foreign matter is not removed, and the state in which the target cam phase and the actual cam phase deviate from each other continues.

In order to remove the foreign matter 60, the control (foreign matter discharge control) of moving the spool 46 in the left direction in the drawing to enlarge the gap between the housing 45 and the spool 46 is required for releasing the foreign matter 60 and causing the foreign matter 60 to flow away together with oil. A method of the foreign matter discharge control will be described hereinafter.

### EXAMPLE 1

An example for the first to third embodiments will be described.

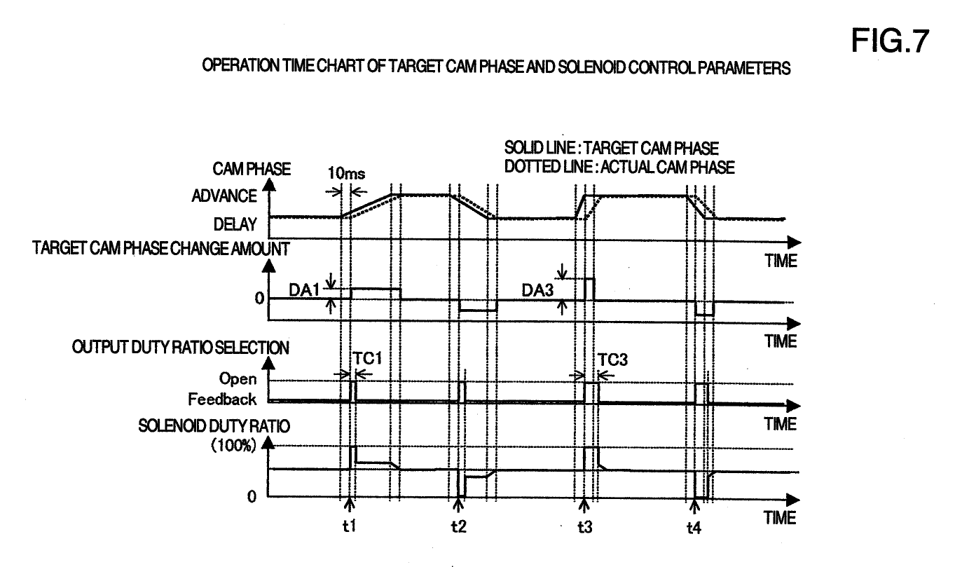

FIG. 7 is a time chart showing the target cam phase and the drive duty ratio of the solenoid 43.

The engine controller 13 detects the operating state and the actual cam phase, and calculates the target cam phase every predetermined time (for example, every 10 ms).

Here, when the operating state changes at a timing t1, and the target cam phase changes to the advance side, the output duty ratio selection is brought into a feedback stop (Open) state, and the solenoid duty ratio outputs 100% which is the maximum value so that the cam phase moves in the advance direction.

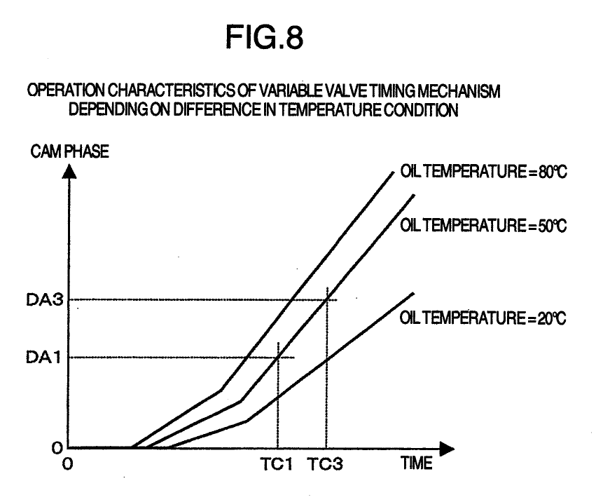

In the case that the target cam phase changing amount at the timing t1 is DA1, a proper characteristic is selected from the operation characteristics of the variable valve timing mechanism depending on the difference of the temperature condition shown in FIG. 8 in accordance with the condition of the oil temperature, and the phase angle changing time with respect to the target cam phase changing amount DA1 is calculated back to calculate an Open state continuation time TC1.

After the Open state continuation time TC1 elapses from the timing t1, the output duty ratio selection is brought into a feedback (Feedback) state, and the solenoid duty ratio is returned into the feedback control so that the target cam phase and the actual cam phase are equal to each other.

Similarly to the timing t1, the output duty ratio selection is brought into a feedback stop (Open) state also at timings t2 and t4, however, in that case, 0% which is the minimum value is output so that the cam phase moves in the delay direction.

At a timing t3, since a target cam phase changing amount DA3 is larger than DA1, an Open state continuation time TC3 calculated from the operation characteristics of the variable valve timing mechanism depending on the difference in the temperature condition shown in FIG. 8 also becomes larger than TC1.

### EXAMPLE 2

Next, an example for the fourth embodiment will be described.

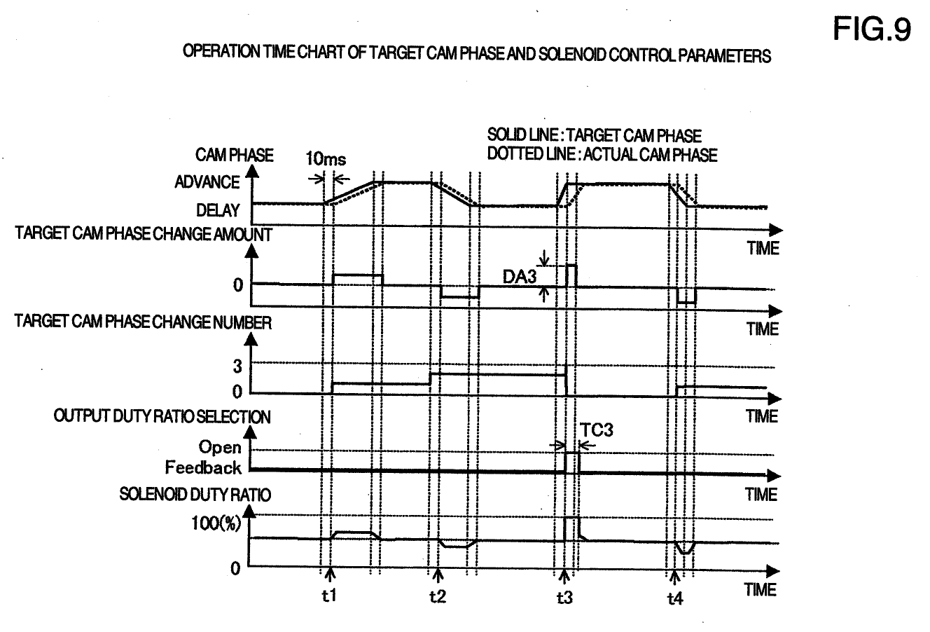

FIG. 9 is a time chart showing the target cam phase and the drive duty ratio of the solenoid 43.

In this example, the control is changed with respect to example 1 by adding a target cam phase changing number representing how many times the target cam phase changing amount is changed from a state of zero to a state other than zero, and bringing the output duty ratio selection into the feedback stop (Open) state if the target cam phase changing number reaches three.

As a result, the frequency of becoming the feedback stop state can be reduced.

### EXAMPLE 3

Next, an example for the fifth embodiment will be described.

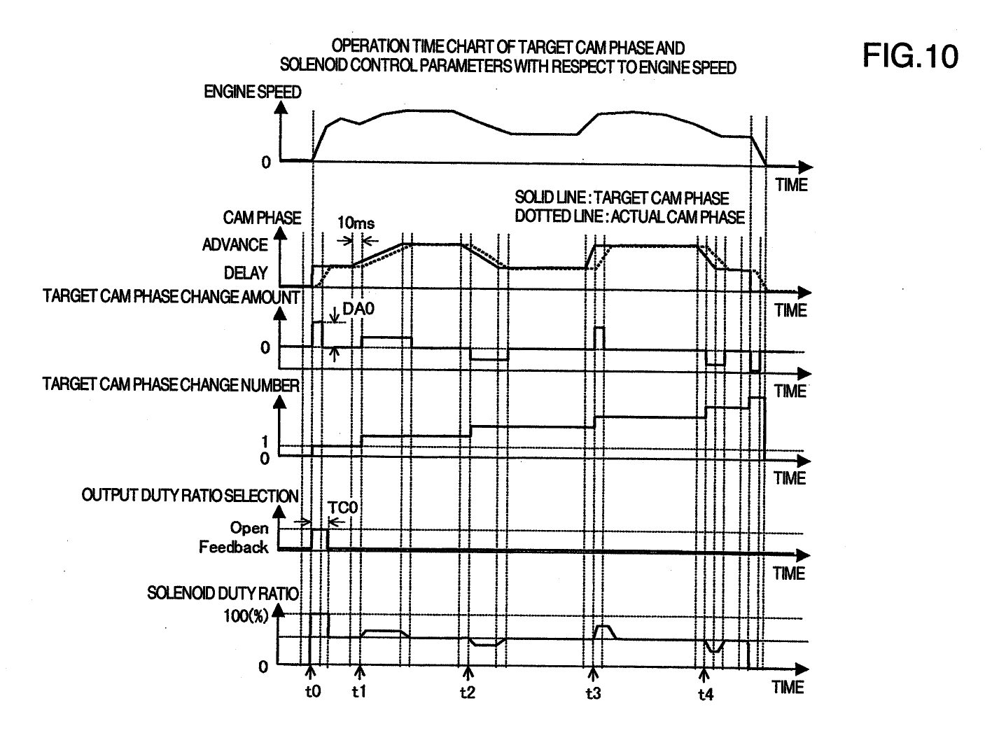

FIG. 10 is a time chart showing the target cam phase and the drive duty ratio of the solenoid 43 with respect to the engine speed.

In this example, the control is changed with respect to example 1 by adding the target cam phase changing number representing how many times the target cam phase changing amount is changed from the state of zero to the state other than zero, and bringing the output duty ratio selection into the feedback stop (Open) state if the target cam phase changing number is one or less. Further, a process of clearing the total target cam phase changing number to be zero when the engine stops is also added thereto.

By doing so, the foreign matter discharge control can be carried out in correspondence with the operation where the target cam phase advances from the latest position after the engine is started.

In the case of an automobile which carries out idle stop such as a hybrid automobile, the engine is frequently started and stopped, and the target cam phase significantly differs between an engine stop state and an engine rotating state in many cases. Therefore, the target cam phase significantly changes every time the engine starts.

That is, since the condition favorable for carrying out the foreign matter discharge control is established every time the engine starts, the foreign matter discharge control can be carried out when the engine starts and immediately after the engine starts so that the feedback stop state is prevented from occurring during a normal operation.

As above, the embodiments including several examples of the present invention have been described in detail. However, the present invention is not limited to the embodiments, and various changes can be made in design without departing from the spirit of the present invention described in the claims.

In the above embodiments, an internal combustion engine including a valve opening characteristic regulating device of an intake valve is described. However, it is obvious that the present invention can be applied to an internal combustion engine including a valve opening characteristics regulating device of an intake valve and an exhaust valve.

Further, the description is made with regard to a variable valve timing mechanism, but it may be replaced with a variable valve lift control device.

In addition, the control of the intake valve is described in each example, but the control can be carried out similarly for the exhaust valve 120.

1. A controller for an oil control valve which drives an actuator to adjust the timing of opening and closing an intake valve or an exhaust valve of an internal combustion engine, comprising:
a feedback means which controls the actuator so that an actual cam phase which is a rotational phase of a cam shaft with respect to rotation of a crankshaft becomes equal to a target cam phase which is defined on the basis of an operating state of the internal combustion engine, wherein
the actuator is driven with a driving amount larger than a driving amount of the actuator by the feedback means for a predetermined time after the target cam phase changes.

2. The controller according to claim 1, wherein the actuator is driven by energizing a solenoid coil.

3. A controller for an oil control valve which drives an actuator by energizing a solenoid coil to adjust the timing of opening and closing an intake valve or an exhaust valve of an internal combustion engine, comprising:
a feedback means which energizes the solenoid coil so that an actual cam phase which is a rotational phase of a cam shaft with respect to rotation of a crankshaft becomes equal to a target cam phase which is defined on the basis of an operating state of the internal combustion engine, wherein
the controller conducts control so that a voltage larger than the energization to the solenoid coil by the feedback means flows through the solenoid coil for a predetermined time after the target cam phase changes.

4. A controller for an oil control valve of an internal combustion engine, comprising:
a variable valve timing mechanism which changes a rotational phase of a cam shaft with respect to rotation of a crankshaft of the internal combustion engine by utilizing hydraulic pressure of a working fluid to adjust the timing of opening and closing a valve driven by the cam shaft;
an oil pump which pressurizes and discharges the working fluid to the variable valve timing mechanism;
an oil control valve provided between the variable valve timing mechanism and the oil pump for adjusting the hydraulic pressure to the variable valve timing mechanism by adjusting a moving amount of a spool by control of an actuator;
an operating state detecting means which detects an operating state of the internal combustion engine;
a target cam phase calculating means which calculates a target cam phase based on a detection result of the operating state detecting means;
an actual cam phase detecting means which detects the rotational phase of the cam shaft with respect to the rotation of the crankshaft; and
a means for conducting feedback control of the actuator so that the actual cam phase becomes equal to the target cam phase, wherein
the controller further comprising a control amount changing control means which controls the actuator with a predetermined control value different from a control value calculated by the feedback control means only for a predetermined time after the target cam phase changes.

5. The controller for an oil control valve of an internal combustion engine according to claim 4, wherein the predetermined control value is set so that the rotational phase of the cam shaft moves in a change direction of the target cam phase.

6. The controller for an oil control valve of an internal combustion engine according to claim 4, wherein the predetermined time is set based on a changing amount of the target cam phase per unit time.

7. The controller for an oil control valve of an internal combustion engine according to claim 4, wherein the number of times of changes of the target cam phase is summed, and if the summed number reaches a predetermined value, the actuator is controlled with the predetermined control value different from the control value calculated by the feedback control means while the summed number is cleared.

8. The controller for an oil control valve of an internal combustion engine according to claim 4, wherein after the internal combustion engine is started until the internal combustion engine is stopped, the number of times of controlling the actuator with the predetermined control value different from the control value calculated by the feedback control means is restricted within a predetermined number of times or less.
